(19) United States
(12) Patent Application Publication
(10) Pub. No.: US 2004/0208240 A1
(43) Pub. Date: Oct. 21, 2004

(54) Data encoding using an oscillator circuit

(76) Inventor: Daniel Kilbank, Potomac, MD (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/828,242

(22) Filed: Apr. 21, 2004

Related U.S. Application Data
(60) Provisional application No. 60/464,095, filed on Apr. 21, 2003.

(51) Int. Cl. H04L 5/16

(52) U.S. Cl. 375/222

(57) ABSTRACT

A system and applicable methods use an oscillator circuit in conjunction with a modem to encode and exchange information. The oscillator circuit provides a reference signal having a phase. The reference signal is selected according to the phase, and corresponds to the probability state of a quantum representation, such as an electron in an encoded bit within an output signal. The probability states are used to represent original data in a lossless manner.

### CROSS REFERENCE TO RELATED APPLICATIONS

This application claims priority of U.S. Provisional Application Serial No. 60/464,095, entitled “System and Method for Using a Microlet-Based Modem,” filed Apr. 21, 2003, the entire contents of which are incorporated herein by reference.

### BACKGROUND OF THE INVENTION

1. Field of the Invention

The present invention relates to encoding and decoding data for exchanging over a network or system. More specifically, the present invention relates to encoding and decoding data using an oscillator circuit that provides reference signals to a selector, wherein a selected reference signal corresponds with a probability state of a quantum representation, such as an electron.

2. Description of the Related Art

Networks and systems are exchanging information at an ever-increasing rate. Demand for larger amounts of data and files is increasing as network infrastructure improves. Many existing and future networks, however, are limited by the components within a network that degrade or limit transmission capacity. A signal is transmitted from one location to another, for example, using a modem. The modem is limited by the transmission medium and modem characteristics within the network, including a modem at another location. Further, limitations may exist on transmitting data using compression algorithms and other known processes that seek to improve transmission capacity or timeliness without sacrificing quality or the size of the desired information. These constraints become more of a factor in limiting access to information in rural or disadvantaged areas, or to locations that cannot support the infrastructure through broadband or high-speed network access.

In addition, storage constraints and limitations on memory resources reduce the effectiveness of large file transfers. For example, if one desires to download a movie from a server on a network, network resources would have to compensate or adjust to allow the flow of the data associated with the video or transmit the video as a high-compressed file. This aspect becomes even more apparent if the video is in real time. Thus, problems exist with existing networks and resources in the transmission of large data files, programs and other information in a timely and efficient fashion without sacrificing the quality of the transmission or losing data via compression, data packet loss and the like.

### SUMMARY OF THE INVENTION

According to the disclosed embodiments, a method for encoding information is disclosed. The method includes generating a plurality of reference signals in an oscillator circuit. The method also includes selecting a frequency signal having a phase from the plurality of reference signals. The phase of the frequency signal corresponds with a probability state of a quantum representation. The method also includes encoding data according to the probability state of the quantum representation.

A system for exchanging information also is disclosed according to the disclosed embodiments. The system includes an oscillator circuit. The system also includes an encoding layer to receive a reference signal from the oscillator circuit. The reference signal has a phase. The system also includes a selector to select the reference signal according to the phase. The phase corresponds to a probability state of a quantum representation. The system also includes an encoder to encode data using the quantum representation.

A modem also is disclosed according to the disclosed embodiments. The modem includes an input to receive data. The modem also includes an oscillator circuit to provide a reference signal having a phase. The modem also includes a selector to select the reference signal according to the phase. The phase corresponds to a probability state of quantum representation. The modem also includes an encoder to represent the data in the quantum representation using the reference signal.

A method for encoding a data block using an oscillator circuit is disclosed. The method includes selecting a reference signal. The method also includes determining a probability state of a quantum representation in response to the reference signal. The method also includes encoding a set of bits with the probability state of the quantum representation.

### BRIEF DESCRIPTION OF THE DRAWINGS

The accompanying drawings, which are included to provide a further understanding of the invention herein are incorporated in and constitute a part of this specification, illustrate embodiments in the invention and together with the description serve to explain the principles of the invention.

FIG. 1 illustrates a block diagram of a system for encoding and exchanging information having an oscillator circuit according to the disclosed embodiments,

FIG. 2 illustrates an oscillator circuit used in encoding data according to the disclosed embodiments,

FIG. 3 illustrates a block diagram of an encoding process according to the disclosed embodiments.

### DETAILED DESCRIPTION OF THE PREFERRED EMBODIMENT(S)

Reference will now be made in detail to the preferred embodiments of the present invention, examples of which are illustrated in the drawings.

The disclosed embodiments are related to multi-state binary encoding that enables lossless storage and transmission over networks for all kinds of high definition media, data and information. The disclosed embodiments may be referred to as a disruptive technology that combines quantum theory physics and information theory. The disclosed embodiments may use computational simulations that behave according to quantum theory principles despite running on classical hardware, systems, networks and the like. Thus, by predicting an understanding of quantum behavior at the particle structure level, the disclosed embodiments may encode data with lossless mapping such that large blocks of data may be transmitted or exchanged over a network. The disclosed embodiments may encode and map data because every quantum system has a set of mathematical rules that describe the dynamics and total energy of the system in terms of the motion of all of its components. Thus, by determining the probabilities of various energy states within quantum representations, such as electrons, the disclosed embodiments may set values according to these probabilities.

A single electron, or quantum representation, may travel along exponentially many different routes in a simultaneous manner. Further, quantum systems may exhibit correlations between states within super positions, or the entangled particles concept. Thus, quantum information may exist as a linear super position of two classical states, such as 1 or 0, at the same time. According to the disclosed embodiments, qubits, or quantum bits, may be homomorphic in that they can transform from one state to another without losing data in the second state. As new qubits are added, the number of states doubles. Thus, a small number of qubits may represent a large number of possibilities and in turn, data. According to the disclosed embodiments, qubit registers may hold super positions of states and by varying amplitude at two states, the disclosed embodiments may create an infinite number of different super positions.

The disclosed embodiments implement probability mathematics that may be used to isolate regions within a Hilbert-Banach (HB) space to a small, finite set of possibilities that allow the practical utilization of computational simulations on known hardware, network, and software systems. Computational simulations may behave at the particle structure level according to quantum theory, such that the amount of information that may be contained on a virtual electron, or quantum representation, may be at least 32 times greater than known technology.

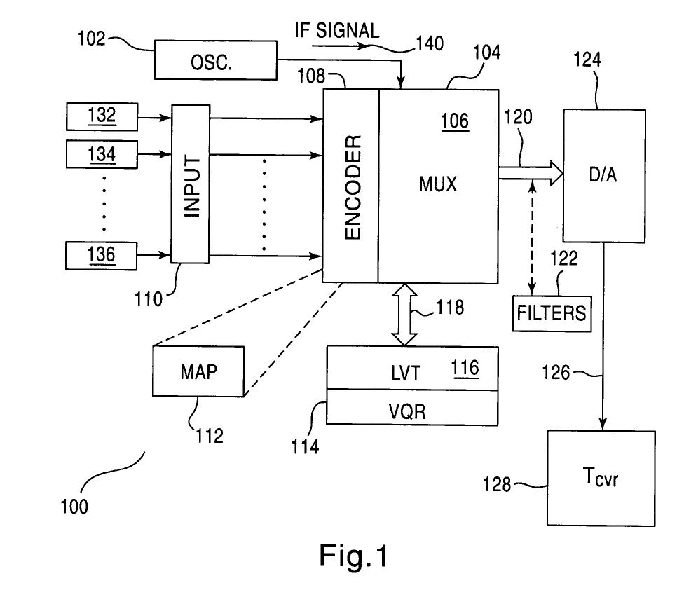

The disclosed embodiments, however, operate at the binary level using zeros and ones. Further, the disclosed embodiments may be implemented by software or other means that is compatible with existing hardware and network components. For example, referring to FIG. 1, an encoding system 100 for encoding and exchanging data having oscillator circuit 102 is illustrated. Encoding system 100 may reside on a modem, transmission device, network, and the like. Encoding system 100 receives data, either digital or analog, and transmits and receives signals representing the data. FIG. 1 illustrates encoding system 100 configured to transmit signals. Alternatively, encoding system 100 may receive a signal and decode the signal into the original data. The decoded data may be without any loss of bits.

Encoding system 100 includes Oscillator circuit 102 that provides reference signals to selector 104. Encoding system 100 also includes digital-to-analog analog converter 124 and transceiver 128. Filters 122 may filter signals from selector 104 to digital-to-analog converter 124.

Selector 104 includes multiplexer 106 and encoder 108. Encoder 108 also may be known as an encoding layer. Encoder 108 may include map function 112. Selector 104 may be coupled to look up table 116 and virtual quantum register 114 via connection 118.

Input 110 of encoding system 100 may input data, or data blocks, into encoder 108. For example, data blocks 132, 134 and 136 may be received by input 110. The number of data blocks may correspond to the number of data streams receivable by input 110. The disclosed embodiments are not limited by the number of inputs shown in FIG. 1. Data blocks 132, 134 and 136 may be of differing data formats, such as video, audio, text, file, compressed data, encrypted data and the like.

Encoding system 100 may be a microlet based system that enables an increased bits-per-cycle and operates in the optimal space between the peak stop band attenuations of wavelet technologies. Encoding system 100 may perform digital signal processing, frequency modulation, frequency phase and phase amplitude vector modulation for wired and wireless communications. Encoding system 100 may be applicable for all communication applications from existing telephone systems through optical/dark fiber, satellite, wireless and the like. Moreover, encoding system 100 may be frequency transparent in that it is transparent to network infrastructure while increasing transmission gain and delivery.

A microlet may be defined in an HB vector space. This principle is used because it necessarily defines both the Hilbert properties as well as allowing for expansion into a Banach space. Thus, the disclosed embodiments may define a vector space. A microlet may be a four-dimensional maximized wavelet packet analyzer sharing similar characteristics, capabilities and functions to wavelets and Fast Fourier Transforms. Microlets, however, are not limited to the dimensional or mathematic constraints of wavelets. A microlet may perform the same transforms of all known wavelet technologies, and more advanced techniques such as adaptive wave packet transfer and discreet periodic wavelet transform.

Microlets may use energy state probabilities as disclosed above. The disclosed embodiments may implement techniques like parallel decomposition and four-dimensional packet analysis to allow for greater detail, range of motion and other fine/course details that may be included on a single waveform, such as signal 126 as shown in FIG. 1. For example, encoder 108 and multiplexer 106 may map data blocks 132, 134, and 136 onto signal 126 using mapping function 112. The disclosed embodiments may use the space between the base band modulation operators to provide the coordinate transformation to rotate data into signal 126. Transceiver 128 may send compressed, coefficient, tagged data, sine and cosine with waveforms, digital information and the like over most infrastructures by replacing packets in a layer of overlapping microlets.

Like wavelet technology, the microlet according to the disclosed embodiments may be a non-binary code that can overlap in time and frequency without interference due to the cross-correlation properties of waveforms. This feature allows for a waveform to carry compressed information that is both compression or encoding related to encoding system 100 and to known compression technologies. Thus, bandwidth efficiency may be increased to exceed the effective rate limited by known modems.

Using base-band encoding and decoding, side band encoding/decoding, and producing heterodyne conversions via Oscillator circuit 102, the disclosed embodiments may use compression and tools to allocate information to various sub-bands and frequencies. Selector 104 may encode this information to allow tagged information to be sent, such as packet, voice, video-on-demand data, and the like, in a bundled package inside of microlets, represented by signal 126, to reach the correct destination. This feature is transparent to all media.

Encoder 108 of selector 104 may operate in a completely lossless environment to add detail and complexity to current technologies. Encoder 108 receives the reference signal from oscillator circuit 102 to map the data to a quantum state with a quantum representation.

Oscillator circuit 102 may include an amplifier with a gain and a frequency dependent feedback loop. Oscillator circuit 102 may oscillate at a desired frequency of oscillation with a total phase shift around a phase locked loop circuit equivalent to 360°. Oscillator circuit 102 may comprise a phase locked loop circuit having a common emitter circuit that provides 180° phase shift. Oscillator circuit 102 also may include a feedback circuit from collector to base that provides an additional 180° phase shift. If a common base circuit is used with an oscillator circuit 102, the main phase shift may exist between the emitter and collector signals and the feedback circuit may provide either 0° or full 360° phase shift.

Oscillator circuit 102 may comprise a multi-phase voltage control oscillator that generates 64 different phases equally dividing a full phase period. Oscillator circuit 102 may be stabilized by the feedback loop. Oscillator circuit 102 may include a frequency divider, frequency-phase detector, and a charge pump.

Multiplexer 106 of selector 104 may select a reference frequency signal having a specific phase. This reference frequency signal may be an intermediate frequency signal. Referring to FIG. 1, frequency signal 140 is disclosed. Frequency signal 140 may be selected from a plurality of reference signals from an oscillator circuit 102.

Encoder 108 may include an encoding layer that has a 4-character map with 7-character sublevels that result in all the possible combinations of the 32 states of an electron and its inverse properties to create a character string of 64 bits. The character map may be included in map function 112. Any resulting character strings may be mapped to look up table 116. This feature may allow for more compression on the look up table or virtual quantum register 114 by identifying course and fine values for each of the above characters. The storage of the differences between the sine samples and the sine waveform should decrease virtual quantum register 114 and information stored on look up table 116. Filters 122 also may facilitate transforming data representations into a signal representation in conjunction with multiplexer 106 or converter 124.

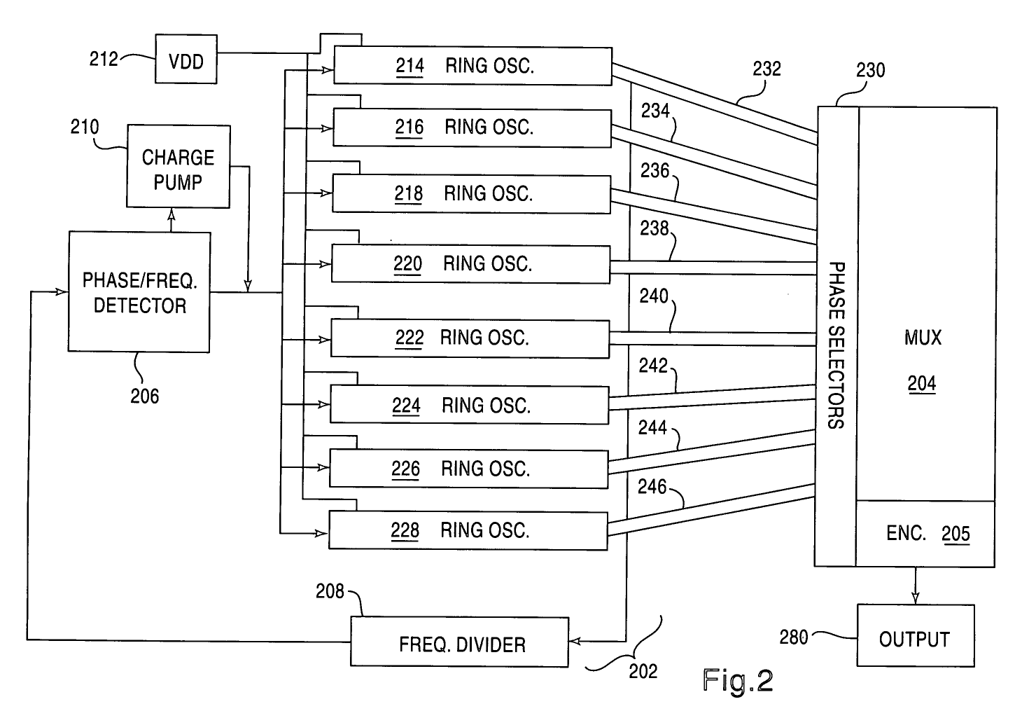

FIG. 2 illustrates an oscillator circuit 200 coupled to a multiplexer 204 according to the disclosed embodiments. Oscillator circuit 202 may be a 4×8 array oscillator with eight mutually-coupled ring oscillators 214, 216, 218, 220, 222, 224, 226, and 228. Oscillator circuit 202 also includes phase frequency detector 206, frequency divider 208 and charge pump 210. Supply 212 may be coupled to the various components within oscillator circuit 202. Supply 212 may be a current supply or a voltage supply. Phase frequency detector may generate a signal, such as a current signal, in response to a difference in phase or frequency between signals outputted from ring oscillators 214-228 and a reference frequency. Charge pump 210 may add or remove current from the signal to ring oscillators 214-228 as appropriate until oscillator circuit 202 is “locked.” Frequency divider 208 may include a divided by four frequency divider. Frequency divider 208 and phase frequency detector 206 provide a feedback loop for oscillator circuit 202. This feedback loop facilitates locking ring oscillators 214-228 to specified frequencies.

Oscillator circuit 202 may be implemented by any known configuration. As noted above, oscillator circuit 202 may comprise a 4×8 array oscillator with eight mutually-coupled ring oscillators. Ring oscillators 214-228 may be coupled with the two adjacent rows of ring oscillators so that a single mode of oscillation may be performed. Ring oscillators 214-228 may include delay cells, poles, capacitance and resistance components that are configured accordingly. For example, ring oscillator 216 may include delay cells having specified phase shifts.

Oscillator circuit 202 may provide output signals 232-246. Oscillator circuit 202 may generate 32 output signals and their complementary signals that are connected to multiplexer 204. Referring to output signals 232-246, these signals may be quadrature output signals. Multiplexer 204 may include phase selectors 230. Phase selectors 230 may comprise 64 phase selectors, matching the 32 output signals and their complementary output signals from oscillator circuit 202. The disclosed embodiments, however, are not limited to 32 distinct phases. Should the disclosed embodiments desire an increased number of phases, oscillator circuit 202 may be configured to output a different number of signals for the phases and the complementary phases.

Phase selectors 230 may include direct digital frequency synthesizers. Phase selectors 230 may perform phase-amplitude vector modulation. Widely used in digital communications, these features offer many improvements including fast continuous phase switching response, fine frequency resolution, large bandwidth, good spectral purity with very low phase noise, and the like.

Multiplexer 204 selects an output signal, or reference frequency signal, from oscillator circuit 202. This reference frequency signal has a phase that correlates or corresponds to a probability state of a quantum representation. As disclosed above, the disclosed embodiments may map, encode or represent data using the probability states of an electron. Multiplexer 204 selects a reference signal, such as reference signal 232, in oscillator circuit 202 that matches the phase desired. Encoder 205 receives the reference frequency signal plus data to be encoded and encodes the data to generate output 280. Output 280 may be a signal or other representation that includes qubit data which mathematically represents the input data received by encoder 205. Further, output 280 includes data encoded by encoder 205 that corresponds to the reference signal from oscillator circuit 202.

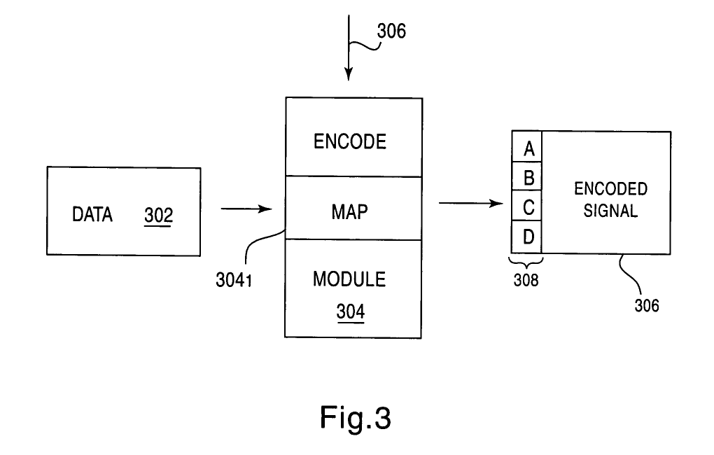

FIG. 3 illustrates a block diagram of an encoding process according to the disclosed embodiments. FIG. 3 discloses the encoding process as it might be applicable to FIGS. 1 and 2. This process may be implemented by encoders, selectors, multiplexers, converters and the like or other components within modems, transmitter/receivers, networks, clients, servers and the like. FIG. 3 includes data block 302, encode module 304 and encode signal 306.

As disclosed above, encode module 304 may use the HB vector space to represent data in the signal. Information may be a vector that is projected onto data of signal coordinate representations, i.e., axes, by rotation of the axes. For example, in each modulation sequence, phase shifting the phase, vector, or waveform at intervals of 22.5° and then shifting that wave at either 450 or 15° phase shifts may allow for multiple states within each wave cycle. Further, the information may be compressed into signal character data strands and tagged prior to being interpreted as a sine wave. For example, encoded signal 306 may be an output as a sine wave or cosine wave. Encoded signal 306 may have attributes of an analog signal in that it can be transmitted over existing modem and information exchange architectures.

Discreet multi-tone may divide the carrier signal into, for example, 247 separate channels, consisting of 4 KHz. Quadrature amplitude modulation and carrierless amplitude phase may operate by dividing the carrier signal into three distinct bands. Both may be carried in the 0-4 kHz band, the upstream band may be limited to the 25-160 KHz range, and downstream may operate from 240-1.5 MHz range, approximately. The disclosed embodiments may implement multiple signals like discreet multi-tone, and may modulate these signals like quadrature amplitude modulation. The modulating/phase shifting of signals from an oscillator circuit, such as oscillator circuit 202 of FIG. 2, the disclosed embodiments may increase the amount of bits per cycle.

Any applicable operators for a modem implementing the process disclosed with reference to FIG. 3 may be constructed in any given input forms, because any band limited signal, even high-speed optical, may be detailed via a sampling theorem. Matrix operators within encode module 304 such as map 3041, may be viewed as geometric locations of a vector, fixed, and floating point values in a coordinate system. For example, referring to FIG. 3, data block 302 is received by encode module 304. Reference signal 306 is received from an oscillator circuit, as disclosed above. Reference signal 306 may have a specified phase and/or specified frequency. The phase of reference signal 306 may correspond or correlate to states to represent data block 302 as it is encoded or mapped by encode module 304. Map 3041 will map data block 302 to these probability states. Map 3041 then may serve as a decoding feature or other component that is retained by an applicable system or network to show the representations of the mapped data in its entirety to encoded signal 306.

Thus, information may be thought of as a vector that may apply its informational properties onto any media via rotation of the axis. For example, data block 302 may be rotated by encode module 304 to generate encoded signal 306. Data block 302 is rotated according to a matrix of mathematical representations to encode data block 302. Data may be modulated into a band limited signal, such as encoded signal 306, using a set of samples into a digital-to-analog conversion module of a base band of a modulator that defines an n-dimensional vector strictly defined in time and bandwidth. These properties pertain to wavelet transforms, in turn, with microlet transforms. The most common method for creating the wavelet transform includes a quadrature mirror filter. Quadrature mirror filters also may be implemented for microlet transforms. The disclosed embodiments may use an iterated filter bank that produces near perfect results, only allowing for a time delay. This feature may be known as a universal discreet wavelet transform. Filter banks allow for wavelet and microlet transform, side-band coding, multi-resolution analysis and other useful applications.

Thus, according to the disclosed embodiments, any real number may be mapped uniquely into 0 or 1 that then is brought together to join encoded signal 306. For example, bit 308 includes uniquely mapped representations A, B, C, and D. A, B, C, and D of bit 308 may represent the probability states of a quantum representation. These probability states may change even though bit 308 does not. Further, bit 208 may be referred to as a qubit, as disclosed above.

Computers may use binary numbers such as 1 and 0 to represent numbers. Any bit sequence may be mapped uniquely and precisely to a number by zeros and ones, however, for practical purposes, computers should not represent an arbitrarily large number in zeros and ones. The number of unique bit sequences decreases as the number of bits in a sequence increases when comparing to total possible number of unique sequences.

Encoded signal 306 will look to a network like an ordinary bit or signal. Bit 308 also may be treated by a network like an ordinary bit. When encoded signal 306 and bit 308 is decoded, however, an exact representation of the original information within data block 302 may be produced. Quantum theory states that everything in nature including all information, may be described by a finite number of information constructs. The disclosed embodiments may use synthetic intelligence, such as rule-based software agents, that are trained for efficient pattern analysis and use a genetic evolutionary method to reduce the number of information constructs to a manageable number, so that the disclosed embodiments may be executed and integrated with known hardware, software, networks and the like.

Thus, the disclosed embodiments may operate in processing microlets exclusively at the binary level, which increases simplicity and integratability. Encoding information, such as encoded signal 306, may look to the network like ordinary bits over an existing network infrastructure. Synthetic intelligent agents may reduce information constructs so steps for encoding, such as that used by encode module 304, are not computationally intensive.

Referring to FIG. 3, a finite number of states may exist in a quantum representation, such as an electron. The disclosed embodiments isolate regions within an HB space to determine probabilities of energy levels within these regions. These probability levels of the energies then become the representations of data or information, such as data block 302. The probabilities may be represented in bit 308 as quantum states A, B, C, or D. These states also may be known by quantum numbers.

The disclosed embodiments may implement microlets that are unique technology blended with quantum mathematics and wavelet technology. The dynamics of filtering and wave shaping may be adjusted or changed as is done in existing wavelet systems. Switching devices may be implemented with the benefits of wavelet mathematics or microlet transforms. These benefits may include canceling noise and interference and bringing the transforms from non-microlet soures. A transport layer within the network may transport microlet transforms such as those within encoded signal 306 over a transmission medium.

Microlet transforms may be shown in FIG. 3 as bit 308, and quantum states A, B, C, and D. Thus, the feature of using microlets in the disclosed embodiments, may retain the unique properties of wavelets to increase transmission capacity and reduce interference with the benefits of multidimensionality shown by representing the probabilities of energy within the quantum representation, such as an electron. The wave may be re-shaped by other components within an applicable modem architecture. Unlike wavelets, microlets may not be limited by using transforms, physical interference or two bits per wavelength.

Map 3041 may reside in encode module 304. Map 3041 may be a mathematical representation that facilitates encoding data block 302. These mathematical representations may behave according to quantum theory principles even though they are being executed on existing hardware, software or network systems. The mathematical model representations of map 3041 may behave according to quantum theory even though they are executing in known systems. Probabilities, which are rule-defined and software-agent controlled, may be assigned to a set of binary alternatives. These rule-based software agents may include memory, such that the software agents learn about the environment, and because the software agents are dynamic software agents, and the software program has attributes of actual electrons or quantum behaviors, the software agents may learn, adapt and cooperate within a virtual electron multi-agent environment. The distributed processing of the internal network of virtual agents, such as map 3041, may act like a neural net which allows them to build on past experience and new updates. For example, map 3041 may be linked to additional maps or encode modules 304 to develop a neural net that exchanges information experiences and updates.

By applying the rules into an algorithm within encode module 304 that designates the four quantum numbers and their behavior to a mapped model, the disclosed embodiments may be able to generate a single transform that represents the embodied information stored in an electron, or quantum representation, in a pseudo-electron environment. The transforms also may include invertible functions that allow them to be decoded in a less complex manner. A four-dimensional lattice/array is utilized to collect information, and compile binary mapping that is run through a synthetic quantum algorithm within encode module 304 and the ordinary bits of binary or analog information are transposed into an electron-like setting on encoded signal 306.

Transforms according to the disclosed embodiments may inhabit minimal space such that they can be mapped in a very diverse library code book. Because the encoding occurs in a near-perfect environment and there is a symmetrical relationship, the decoding is the inverse operation of the encoding. The disclosed embodiments normalize individual affine transforms into encoded signal 306 easily by using various processes to minimize data like competing conditional probabilities and establishing the hierarchical tracings forwarded into categories backwards to the source. For example, in the case of a high resolution picture going into the library, the algorithm within encode module 304 may encode the series of n-dimensional arrays. The values of the n-values defined in the former's element grid-points of the hypothetical data set are stored for clarity and to allow interpolations. In order to make such data set self-contained, to facilitate access and to remove the possibility of ambiguity, arrays containing the values of each of the parameters in which that data set depend are therefore contained alongside the n-dimensional array containing the calibration data set.

An amplitude of probability state functions may be used to measure the amplitude probability of any given state within the quantum representation, such as an electron, and to calculate the microlet transform. These actions may occur in encode module 304. In further defining and cataloging these amplitudes or states, it may not be necessary to measure just for each symbol in a real-time environment. After an affine definition is assigned, any of the changes in symbols may be measured and sent, and these will be stored in the virtual quantum register library, as disclosed above. Because by definition these n-bits may be in any super position of both states, the microlet transform, such as bit 308, may fulfill the transform function of the argument. Thus, data block 302 may be mapped in a lossless manner to encoded signal 306. The disclosed embodiments include mapping data block 302 in a one-to-one fashion into encoded signal 306. Encoded signal 306 then may be transmitted or exchanged within a network. Encoded signal 306, once received, may be decoded back to data block 302 in its entirety. Data block 302 may comprise compressed data, encoded data or raw data.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims and their equivalents.

We claim:

1. A method for encoding information, the method comprising:
generating a plurality of reference signals in an oscillator circuit;
selecting a frequency signal having a phase from the plurality of reference signals, wherein the phase of the frequency signal corresponds with a probability state of a quantum representation; and
encoding data according to the probability state of the quantum representation.

2. The method of claim 1, further comprising mapping the data to a look up table.

3. The method of claim 1, wherein said selecting comprises selecting the frequency signal with a multiplexer.

4. The method of claim 1, further comprising defining a plurality of quantum representations, including the quantum representation.

5. The method of claim 4, wherein defining the plurality of quantum representations comprises defining possible combinations of states of an electron.

6. The method of claim 1, further comprising compressing the data into a single character data strand.

7. The method of claim 1, wherein said encoding comprises encoding using a Banach/Hilbert vector space.

8. The method of claim 7, further comprising stabilizing the oscillator circuit to generate the plurality of reference signals.

9. The method of claim 8, wherein the stabilizing comprises stabilizing the oscillator circuit to generate the plurality of reference signals, wherein the plurality of reference signals correspond to probability states of a quantum representation.

10. A system for exchanging information, the system comprising:
an oscillator circuit;
an encoding layer to receive a reference signal from the oscillator circuit, wherein the reference signal includes a phase;
a selector to select the reference signal according to said phase, wherein said phase corresponds to a probability state of a quantum representation; and
an encoder to encode data using the quantum representation.

11. The system of claim 10, wherein the encoding layer defines combinations of state of a quantum representation.

12. The system of claim 10, wherein the encoder encodes using the quantum representation, wherein the quantum representation is an electron.

13. The system of claim 10, wherein the selector comprises a multiplexer.

14. The system of claim 10, further comprising a look up table to receive encoded data from said encoder.

15. The system of claim 10, wherein said encoder encodes the data to the quantum representation in a lossless manner, such that all of said data is represented.

16. A modem, comprising:
an input to receive data;
an oscillator circuit to provide a reference signal having a phase;
a selector to select the reference signal according to the phase, wherein the phase corresponds to a probability state of a quantum representation; and
an encoder to represent the data in the quantum representation using the reference signal.

17. The modem of claim 16, wherein the encoder comprises mapping functions to represent the data.

18. The modem of claim 17, wherein the mapping functions comprise a set of mathematical forms that are reversible.

19. The modem of claim 17, wherein the mapping functions are invertible functions.

20. A method for encoding a data block using an oscillator circuit, the method comprising:
selecting a reference signal;
determining a probability state of a quantum representation in response to the reference signal; and
encoding a set of bits with the probability state of said quantum representation.

21. The method of claim 20, wherein said selecting step comprises selecting the reference signal, and wherein the reference signal includes a phase.

22. The method of claim 20, wherein said determining step comprises determining the probability state of said quantum representation, and wherein said quantum representation is an electron.

23. The method of claim 22, further comprising forming said electron as a virtual electron.

24. The method of claim 20, further comprising generating a microlet transform from said encoded set of bits.
